(19) United States
(12) Patent Application Publication
(10) Pub. No.: US 2006/0095947 A1
(43) Pub. Date: May 4, 2006

(54) Digital set-top terminal configured to receive analog signals

(76) Inventor: Samuel H. Russ, Lawrenceville, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 10/981,090

(22) Filed: Nov. 4, 2004

(51) Int. Cl. H04N 7/173; H04N 7/16

(52) U.S. Cl. 725/100; 725/131; 725/151

(57) ABSTRACT

Systems and methods are disclosed in which analog television channels can be passed through digital set-top terminals. In some embodiments, among others, a switch and a splitter are included in a digital set-top terminal. The splitter is configured to receive a broadcast signal, and direct the broadcast signal to a first path and a second path. The first path has digital tuning circuitry, which processes the broadcast signal to produce an output signal for display on a television. The switch is located in the second path. The switch receives the broadcast signal from the splitter and the output signal from the digital tuning circuitry. The switch then selects between the broadcast signal and the output signal from the digital tuning circuitry. The selected signal is then output to a television.

### TECHNICAL FIELD

The present disclosure relates generally to broadcast media and, more particularly, to analog and digital broadcast media.

### BACKGROUND

There are a variety of set-top terminals (STTs), which are also commonly referred to as set-top boxes. Some STTs, are configured for both analog and digital tuning, while other STTs are only configured for digital tuning. Those STTs that are “digital only” are much less expensive to manufacture, since digital-only STTs can be manufactured without incurring costs that are associated with analog tuning hardware. Often, analog tuning requires up-down converters that properly modulate the analog signals. These up-down converters, which are known in the art, are relatively expensive hardware modules.

Unfortunately, while digital-only STTs can be manufactured and sold for less than STTs with analog-capable tuners, the purchaser of a digital-only STT is likely limited to digital television channels because the digital-only STT does not have the capability of tuning to analog channels. Alternatively, a cable subscriber may have to purchase an analog-and-digital STT, which is more costly than a digital-only STT, for viewing both analog and digital television channels.

In view of this deficiency, there is a need in the art for a lower-cost STT that has both analog and digital capabilities.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a conventional digital cable set-top terminal.

FIG. 2 shows a conventional digital satellite set-top terminal.

FIG. 3 shows a conventional set-top terminal capable of both analog and digital reception.

FIG. 4 shows an embodiment, among others, of a digital cable set-top configured to pass through analog signals to a television.

FIG. 5 shows an embodiment, among others, of a digital satellite set-top terminal configured to pass through analog signals to a television.

FIG. 6 shows an embodiment, among others, of a terrestrial digital set-top terminal configured to pass through analog and digital terrestrial signals.

FIG. 7 shows an embodiment of a process, among others, for switching from an analog channel to a guide.

FIG. 8 shows an embodiment of a process, among others, for switching from an analog channel to a digital channel.

FIG. 9 shows an embodiment of a process, among others, for switching from a digital channel to an analog channel.

FIG. 10 shows an embodiment of a process, among others, for switching from a digital channel to a guide.

FIG. 11 shows an embodiment of a process, among others, for switching from a guide to a digital channel.

FIG. 12 shows an embodiment of a process, among others, for switching from a guide to an analog channel.

FIG. 13 shows an embodiment of a process, among others, for fabricating a digital set-top terminal configured to receive analog signals.

### DETAILED DESCRIPTION OF THE EMBODIMENTS

Reference is now made in detail to the description of the embodiments as illustrated in the drawings. While several embodiments are described in connection with these drawings, there is no intent to limit the invention to the embodiment or embodiments disclosed herein. On the contrary, the intent is to cover all alternatives, modifications, and equivalents.

Given the need, as described above, this disclosure teaches various systems and methods by which analog television channels can be provided through lower cost set-top terminals (STTs), such as by modifying a digital STT to pass through analog television channels. In some embodiments, among others, a switch and a splitter are installed in a digital STT, thereby modifying the digital STT for analog reception. The splitter is configured to receive a broadcast signal, and direct the broadcast signal to a first path and a second path. The broadcast signal includes the signals for both digital television channels as well as analog television channels.

The first path has digital tuning circuitry, which processes the digital television channel signals in accordance with known methods for processing digital television channel signals. The digital processing produces an output signal for display on a television.

The switch is located in the second path. The switch receives the broadcast signal from the splitter and the output signal from the digital tuning circuitry. The switch then selects between the broadcast signal and the output signal from the digital tuning circuitry. The selected signal is then output to a television.

If the output from the digital tuning circuitry is output to the television, then the television can output the digital television channel. If the broadcast signal is directed through the modified digital STT to the television, then the tuner on the television can be used to tune directly to the analog television channel.

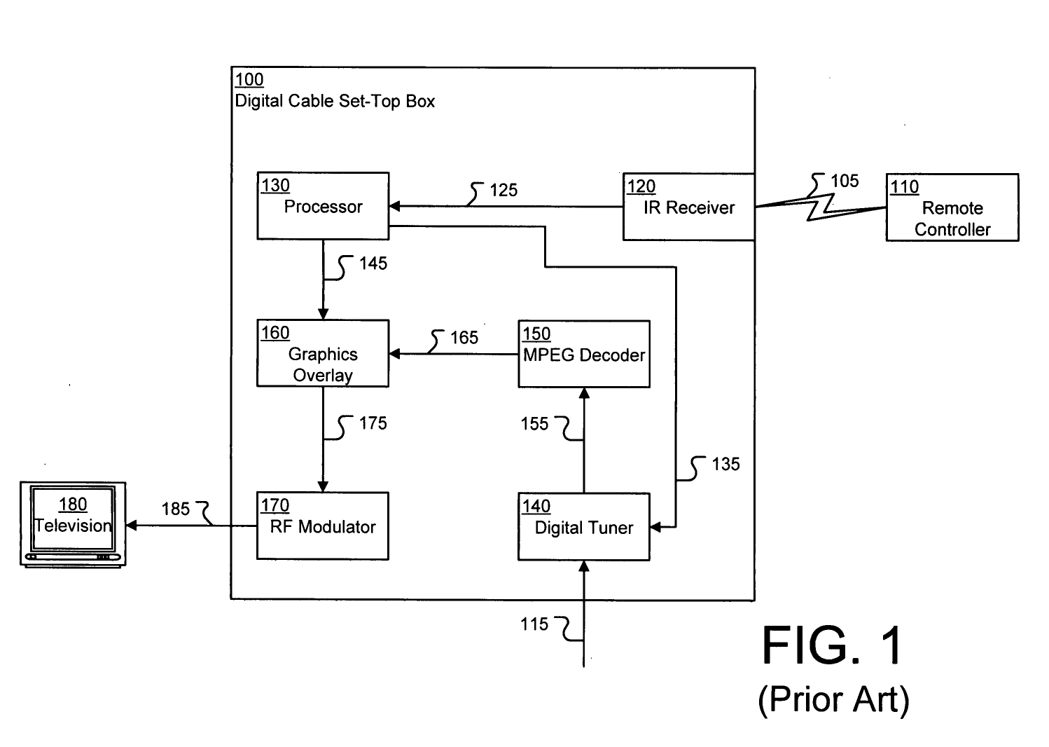

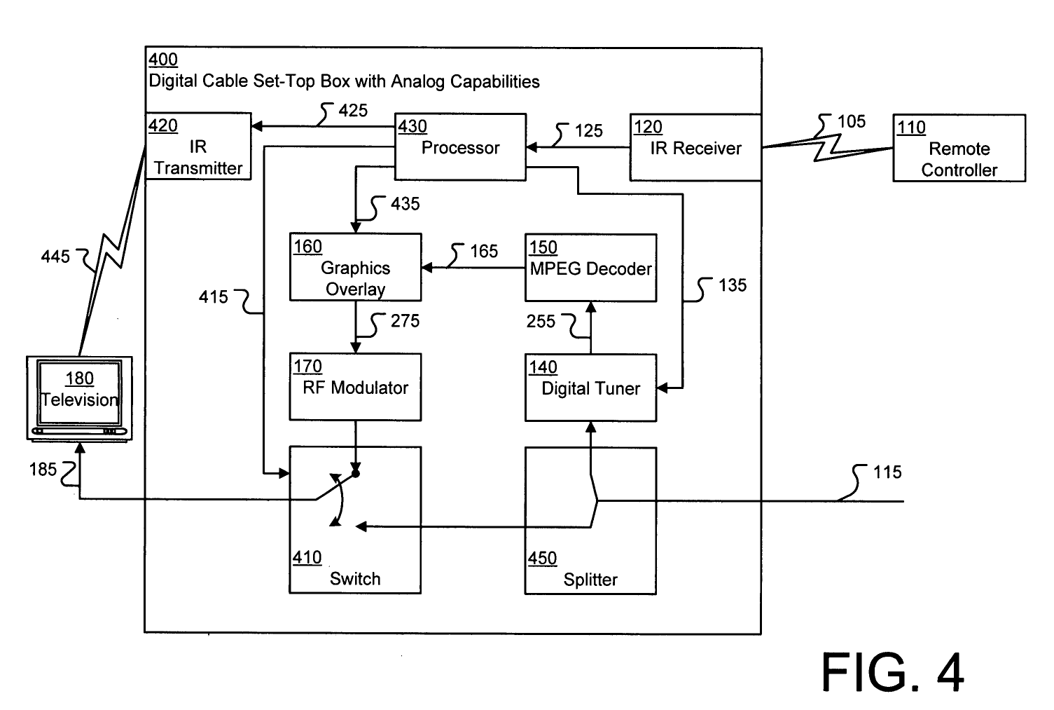

Additional circuitry, as described below, permits a viewer to seamlessly switch between analog and digital television channels without substantial effort. Currently-existing systems are described with reference to FIGS. 1 through 3, while various embodiments of systems and methods for providing both analog and digital television channels are described with reference to FIGS. 4 through 13.

FIG. 1 shows a conventional digital-only cable set-top terminal (STT) 100. Since such digital-only cable STTs are well-known in the art, only a cursory description of the digital STT 100 is provided below.

As shown in FIG. 1, in addition to other components (not shown), the digital-only cable STT 100 includes an infrared (IR) receiver 120, a processor 130, a digital tuner 140, a motion pictures expert group (MPEG) decoder 150 (or other decoders for various known digital compression schemes), graphics overlay logic 160, and a radio-frequency (RF) modulator 170. The IR receiver 120 receives an IR signal 105 from a remote controller 110, which normally accompanies the digital-only STT 100 at the point of sale. The IR signal 105 is indicative of a viewer's selection of a digital cable channel.

The digital-only cable STT 100 receives digital cable signals from a cable 115, which is communicatively coupled to a cable head-end (not shown). When the viewer selects a channel, using the remote controller 110, the IR receiver 120 receives that signal from the remote controller 110 and conveys the selection to the processor 130. The processor 130 instructs the digital tuner 140 to tune to the selected channel.

The digital tuner 140, upon tuning to the selected channel, directs the signal to the MPEG decoder 150, which decodes the digital cable channel signal from the digital tuner 140. The decoded signal 165 is conveyed to the graphics overlay logic 160, which selectively overlays graphics onto the decoded signal.

The resulting signal 175 is conveyed to the RF modulator 170, which properly modulates the signal for reception and viewing at a television (TV) 180. Without any analog decoding components, the digital-only cable STT 100 of FIG. 1 provides a relatively cost-efficient approach to viewing cable TV (CATV) channels.

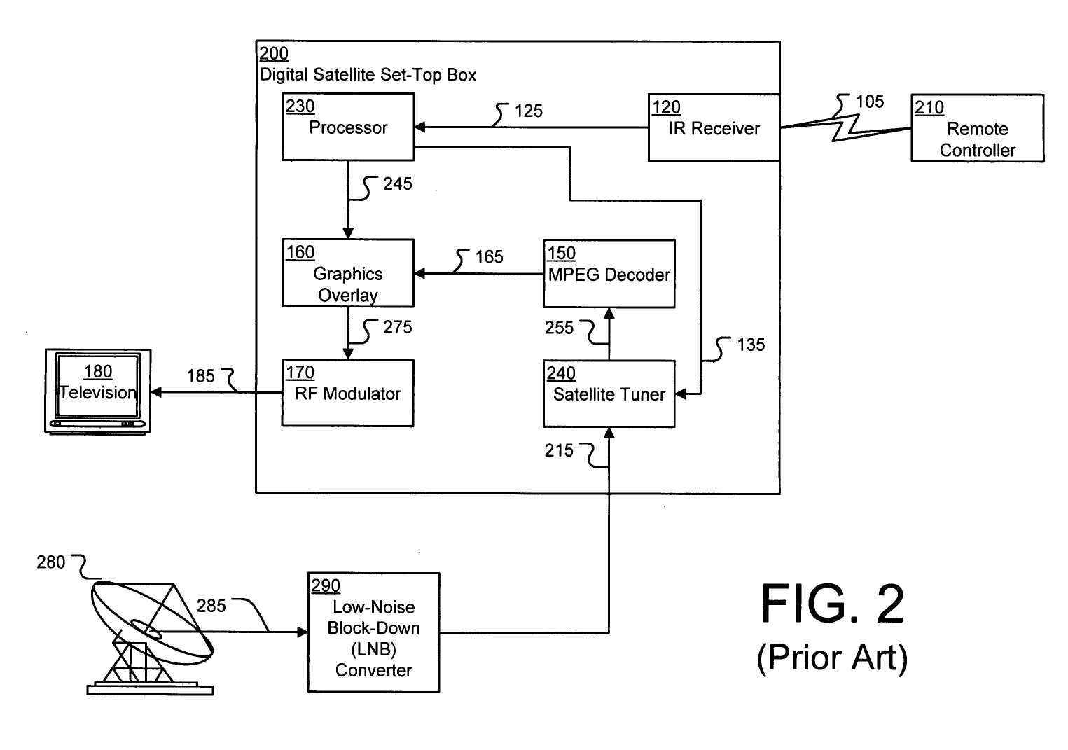

FIG. 2 shows a digital-only satellite STT 200. As shown in FIG. 2, the relevant components of the digital-only STT 200 are, for the most part, similar to the components of the digital-only cable STT 100 of FIG. 1. One difference between FIG. 1 and FIG. 2 is that the digital-only satellite STT 200 receives its signal 215 from a satellite receiver 280 (e.g., a satellite dish) through a low-noise block-down (LNB) converter 290. As such, rather than having a digital cable tuner 140, the digital-only satellite STT 200 has a satellite tuner 240. Correspondingly, the digital-only satellite STT 200 has a processor 230 that is configured to receive the channel selection from a viewer, and instruct the satellite tuner 240 to tune to the selected digital satellite channel, in accordance with known methods.

Similar to the digital-only cable STT 100 of FIG. 1, the absence of analog decoding components from the digital-only satellite STT 200 of FIG. 2 permits cost-efficient manufacturing of the digital-only satellite STT 200.

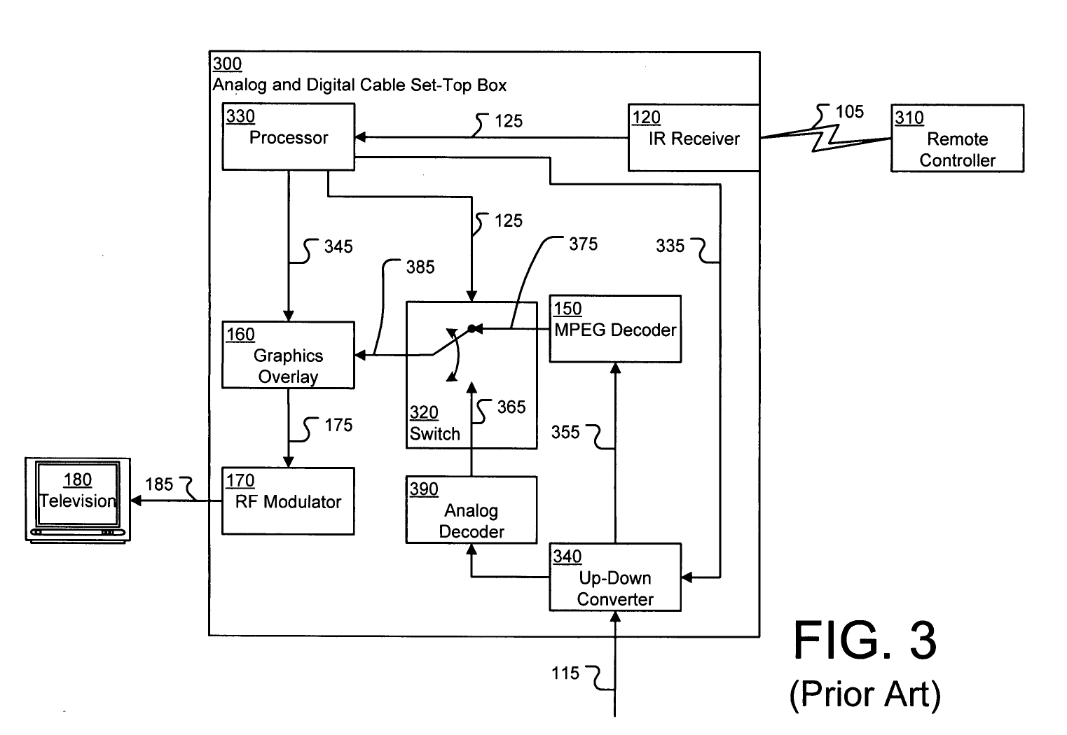

FIG. 3 shows a set-top terminal 300 capable of both analog and digital reception (hereinafter referred to as “a conventional A+D STT”), which includes a known up-down converter 340. As shown in FIG. 3, in addition to many components shown in FIG. 1, the A+D STT 300 includes an up-down converter 340, an analog decoder 390, a switching device 320 (e.g., a physical switch or other device that affects switching), and a processor 330 that controls the operation of the switch 320 and the up-down converter 340, in accordance with known methods. Since A+D STTs and corresponding methods of operation are known in the art, only a truncated discussion of the A+D STT 300 is provided herein.

As shown in FIG. 3, the A+D STT 300 receives a cable signal from a cable headend (not shown) through the up-down converter 340. The up-down converter 340 converts the incoming signal to an intermediate frequency (IF), as is known in the art, for subsequent demodulation and/or decoding.

When a viewer selects a digital channel using the remote controller 310, the remote controller 310 transmits an IR signal 105, which corresponds to the viewer's selection, to the IR receiver 120, which then conveys that selection to the processor 330. The processor 330 issues appropriate instructions, in accordance with known methods, to the up-down converter 340, which converts the incoming signal to the IF, as noted above, and then demodulated to a digital bit-stream. Substantially simultaneously, the processor 330 effectively sets the switch 320 to the MPEG decoder 150.

Thus, when the viewer selects a digital channel, the received and tuned cable signal is directed through a digital path, which includes the MPEG decoder 150 and the graphics overlay logic 160. The resulting signal is RF modulated by the RF modulator 170 and passed to the TV 180 for viewing.

Alternatively, when the viewer selects an analog channel for viewing, the remote controller 310 transmits an IR signal 105, which corresponds to the viewer's analog selection, to the IR receiver, which again conveys that selection to the processor 330. The processor 330 issues appropriate instructions to the up-down converter 340, which tunes to the selected analog channel. The processor 330 also sets the switch 320 to the analog decoder 390.

Thus, when the viewer selects an analog channel, the received and tuned analog signal is directed through the analog path, up-down converter 340, which converts the signal to the IF for further processing. The IF signal is conveyed to the analog decoder 390, which decodes the analog signal. Since the switch 320 is set to the analog decoder 390, the decoded signal is conveyed from the analog decoder 390 to the graphics overlay logic 160 for appropriate processing, in accordance with known methods. The processed signal 175 is RF modulated by the RF modulator 170, and passed to the TV 180 for viewing by the viewer.

As shown in FIG. 3, the A+D STT 300 includes, among other components, an up-down converter 340 and an analog decoder 390. The addition of these two components substantially increases the cost of production of the A+D STT 300, compared to the costs for the digital-only satellite STT 200 and the digital-only cable STT 100.

FIGS. 4 through 6 show various embodiments of STTs that permit both analog and digital reception without employing relatively-expensive hardware, such as the analog decoder 390 and the up-down converter 340 of FIG. 3.

FIG. 4 shows an embodiment, among others, of a digital cable STT 400 configured to pass analog signals. As shown in FIG. 4, the embodiment of the digital cable STT 400 includes conventional components, such as, for example, an IR receiver 120, an MPEG decoder 150, a digital tuner 140, an RF modulator 170, and graphics overlay logic 160. The digital tuner 140 is configured to receive-cable signals through an input port 115, which receives the cable signal from the coaxial cable or a hybrid-fiber-coaxial cable. Since these components are-known in the art, only a truncated discussion of these components is provided when relevant. Of course, other embodiments would not exclude new functionality from such devices.

In addition to these preferably conventional components, the digital STT 400 includes an IR transmitter 420, a splitter 450, a switch 410, and a processor 430 that controls the operation of the digital tuner 140, the switch 410, and the IR transmitter 420. The digital STT 400 receives the cable signal through the splitter 450. The splitter 450 has two outputs, each of which is connected to the digital tuner 140 and the switch 410, respectively. Thus, the cable signal is split at the splitter 450 and directed to both the digital tuner 140 and the switch 410. For some embodiments, the splitter can also include a mechanism to compensate for any attenuation that may be present due to the splitting of the cable signal.

The switch 410 has two inputs and a single output. The single output of the switch 410 is coupled to the television (TV) 180, while the two inputs are each coupled to the RF modulator 170 and one of the outputs of the splitter 450, respectively. In that regard, the switch 410 switches between the RF modulator 170 and the splitter 450.

Thus, in operation, when a viewer selects a digital channel for viewing using the remote controller 110, the remote controller 110 broadcasts a signal that is indicative of the viewer's selection. The IR receiver 120 on the digital STT 400 receives the IR signal 105, which is conveyed from the IR receiver 120 to the processor 430.

The processor 430, in response to the viewer's selection, instructs the digital tuner 140 to tune to the selected digital channel. Additionally, the processor 430 sets the switch to the RF modulator 170 position. In other words, the processor 430 sets the switch 410 to receive its input from the RF modulator 170. In addition to switching and tuning, the processor conveys a signal to the IR transmitter 420 so that the IR transmitter 420 can signal for a change to the channel on the TV 180 to a predefined channel to receive its input from the digital cable STT 400, e.g., channel 3 or channel 4, etc.

Thus, when a digital channel is selected by the viewer, the digital cable STT 400 processes the cable signal using the digital circuitry, which includes the digital tuner 140, the MPEG decoder 150, the graphics overlay logic 160, and the RF modulator 170, in addition to other known components in digital cable STTs.

Alternatively, when the viewer selects an analog channel using the remote controller 110, that selection is conveyed to the digital cable STT 400 by the remote controller 110. The IR receiver 120 receives the viewer's selection, and conveys that selection to the processor 430. The processor 430 sets the switch 410 to directly receive the cable signal from the splitter 450, which forwards the cable signal directly to the switch 410.

In addition to setting the switch 410 so that the cable signal passes through the digital cable STT 400, the processor 430 conveys a signal to the IR transmitter 420 so that the IR transmitter 420 can signal for a change of the channel on the TV 180 to the selected analog channel. By changing the channel on the TV 180 to the selected analog channel, the TV 180 now uses its internal TV tuner to tune to the selected analog channel. In other words, the cable signal passes through the digital cable STT 400 to the TV 180, and the TV 180 uses its internal tuner to tune to the selected analog TV channel.

In contrast to the A+D STT 300, which includes relatively expensive analog components, the pass-through mechanism of FIG. 4 permits apparent dual tuning (analog and digital) with the addition of relatively simple and inexpensive components, such as a splitter 450, a switch 410, and an IR transmitter 420, along with relatively few modifications to the programming of the processor 430. Since the programming of the processor 430 will be relatively straight-forward to one having skill in the art, once the processor functions have been appropriately defined, further discussion of the processor 430 is omitted with reference to FIG. 4.

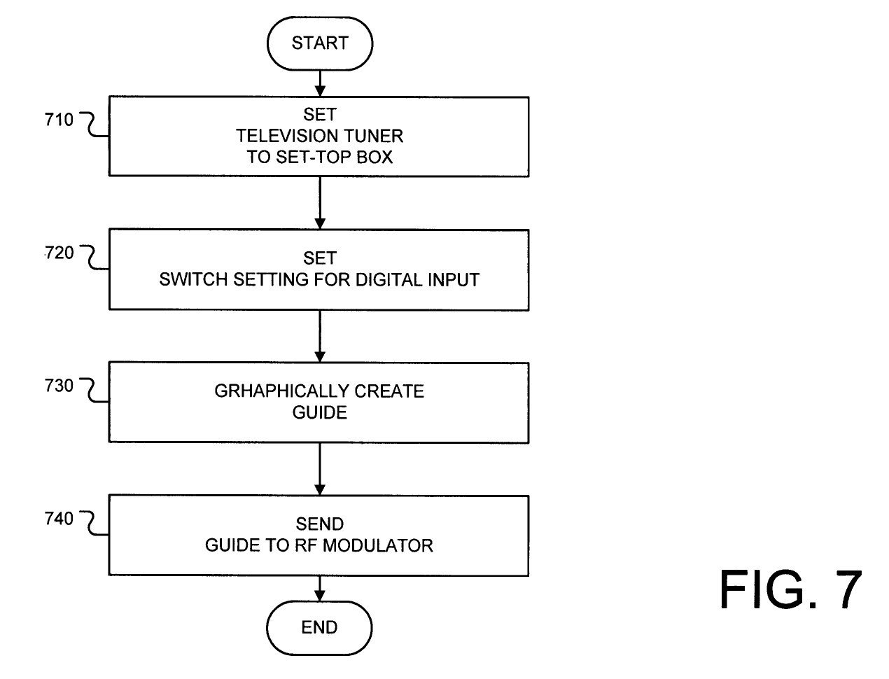

It should, however, be noted that, since the embodiment of FIG. 4 provides a pass-through mechanism, rather than true analog tuning by the digital cable STT 400, the graphics overlay 160 is bypassed when an analog channel is selected. Thus, various embodiments, as shown in FIGS. 7 through 12, teach methods for providing a uniform display, regardless of whether a digital channel is selected or an analog channel is selected. In addition, other embodiments include other hardware and software architectures for accomplishing one or more of the functions described herein.

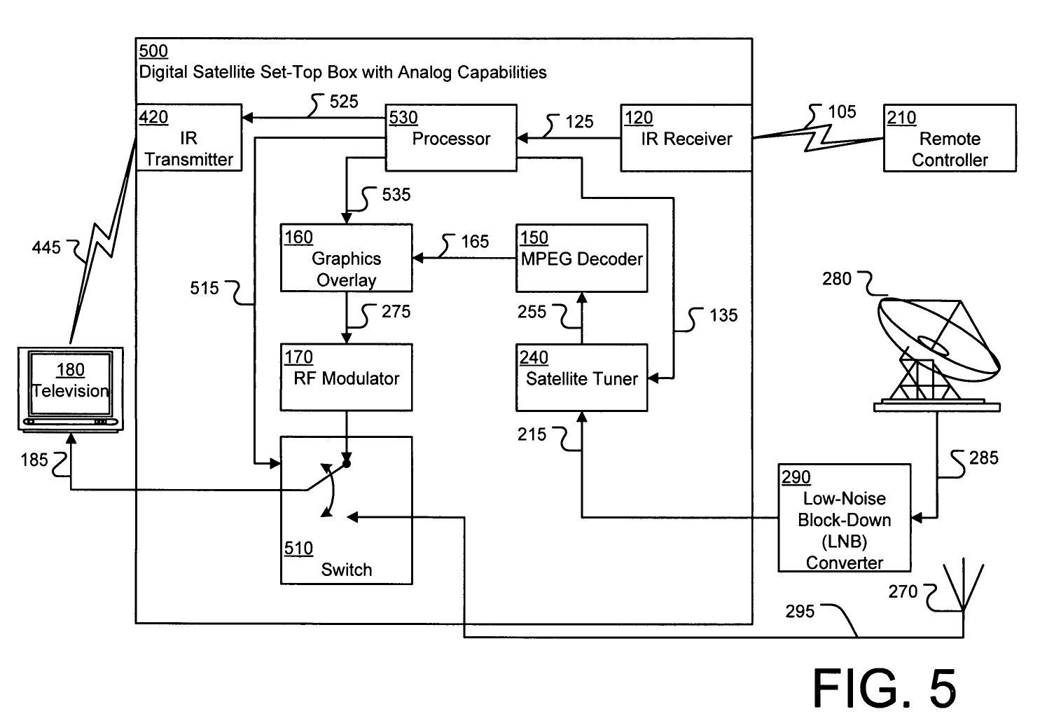

FIG. 5 shows an embodiment, among others, of a digital satellite STT 500 configured to pass through analog signals to a television 180. As shown in FIG. 5, the digital satellite STT 500 includes an IR receiver 120, an MPEG decoder 150, graphics overlay logic 160, an RF modulator, and a satellite tuner 240, which are components associated with a conventional digital-only satellite STT 200, as shown in FIG. 2. However, unlike FIG. 2, the digital satellite STT 500 of FIG. 5 further includes a switch 510 and an IR transmitter 420. Additionally, the processor 530 of the digital satellite STT 500 is modified to control the IR transmitter 420 and the switch 510. Since such modifications will be within the skill of one having ordinary skill in the art, in view of the processor functions as described below, only a truncated discussion of the processor 530 is provided with reference to FIG. 5

The satellite tuner 240 is coupled to a satellite receiver 280 (e.g., a satellite dish) through an LNB converter 290. In other words, the digital satellite STT 500 receives satellite signals through an input port 215, which is connected to the LNB converter 290. The switch 510, which is controlled by the processor 530, has two inputs and a single output. The single output of the switch 510 is coupled to the TV 180. One of the two inputs to the switch 510 is coupled to the circuitry that tunes to the satellite signal from the satellite receiver 280. The other of the two inputs to the switch 510 is coupled to an external aerial antenna 270, which receives analog broadcast signals over the air. In other words, the switch 510 has two switch positions, in which the first switch position sets the switch 510 to the processed satellite signal, while the second switch position sets the switch 510 to the external aerial antenna 270. For some embodiments, the second switch position can be connected to an analog cable input, rather than to an aerial antenna.

Thus, in operation, when a viewer selects a digital satellite channel for viewing using the remote controller 210, the remote controller 210 conveys the viewer's selection to the digital satellite STT 500 through an IR signal 105. The IR receiver 120 of the digital satellite STT 500 receives the IR signal 105 and conveys the viewer's selection to the processor 530.

The processor receives the viewer's selection for a digital satellite channel, and instructs the satellite tuner 240 to tune to the selected digital satellite channel, in accordance with known methods. Additionally, the processor 530 sets the switch 510 to receive signals from the RF modulator 170, which is in the processing pathway for the satellite signal. Moreover, the processor 530 sends a signal to the IR transmitter 420 so that the IR transmitter can signal for a change of the channel on the TV 1 80, such that the TV 180 receives its input from the digital satellite STT 500.

Thus, when the satellite tuner 240 has tuned to the selected digital satellite channel, the tuned signal is conveyed to the MPEG decoder 150, which decodes the signal. The decoded signal is then conveyed to the graphics overlay logic 160, which overlays appropriate graphics to the decoded signal, in accordance with instructions received from the processor 530. Since graphics overlay methods are known in the art, no further discussions of graphics overlay is provided with reference to FIG. 5.

The resulting signal is conveyed to the RF modulator 170, which modulates the signal for viewing by the TV 180. Since the switch 510 is set to receive signals from the RF modulator 170, and the TV 180 is tuned to the digital satellite STT 500, the modulated signal from the RF modulator 170 is conveyed to the TV 180 and displayed for viewing by the viewer.

Alternatively, when a viewer selects an analog channel, that selection is conveyed to the digital satellite STT 500 through the remote controller 210. The IR receiver 120 receives the analog channel selection, and conveys that selection to the processor 530.

The processor 530, upon receiving the analog channel selection, switches the switch 510 to receive signals from the aerial antenna 270. Additionally, the processor 530 instructs the IR transmitter 420 to change the channel on the TV 180 to the selected analog channel.

Thus, when a viewer has selected an analog channel for viewing, the digital satellite STT 500 is configured to set the TV 180 to that analog channel, and pass through the analog signal from the aerial antenna 270. The analog tuner that is built-in to the TV 180 will tune to the selected analog channel, thereby permitting a viewer to watch the TV programs on that analog channel.

Similar to the embodiment of FIG. 4, this pass-through mechanism bypasses the graphics overlay logic 160. Thus, for analog channels, the embodiment of FIG. 5 does not permit graphics overlay using the digital satellite STT 500. Various embodiments of processes are presented with reference to FIGS. 7 through 12, which describe methods for providing uniform displays for both digital and analog channel selections by a viewer.

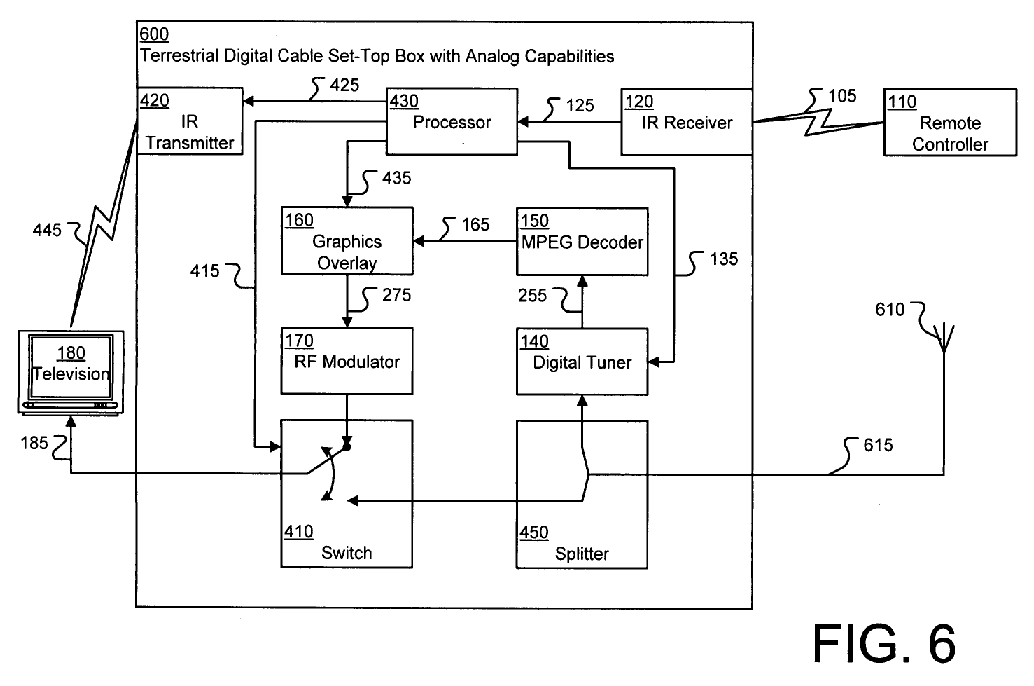

FIG. 6 shows an embodiment, among others, of a terrestrial digital STT 600 configured to pass through analog and digital terrestrial signals. The embodiment of FIG. 6 is substantially similar to the embodiment of FIG. 4. As such, the terrestrial digital STT 600 includes an IR receiver 120, an MPEG decoder 150, a digital tuner 140, graphics overlay logic 160, an RF modulator 170, a switch 410, a splitter 450, a processor 430, and an IR transmitter 420. A difference between the digital cable STT 400 of FIG. 4 and the terrestrial digital STT 600 of FIG. 6 is that the terrestrial digital STT 600 has an input port 615 that is configured to receive over-the-air signals from an aerial antenna 610, rather than from a coaxial cable. As is known, over-the-air signals can be both analog or digital.

Thus, for the terrestrial digital STT 600, over-the-air digital signals received through the aerial antenna 610 are processed through the digital processing circuitry, which includes the digital tuner 140, the MPEG decoder 150, the graphics overlay logic 160, and the RF modulator 170. Conversely, over-the-air analog signals, which are also received through the aerial antenna 610, are passed through the terrestrial digital STT 600 to the TV 180. The TV 180 then tunes to the analog channel, as directed by the IR transmitter 420 and processor 430 of the terrestrial digital STT 600.

As noted with reference to FIGS. 4 and 5, the pass-through mechanism of FIG. 6 bypasses the graphics overlay logic 160. Thus, the analog channel, to which the TV 180 tunes, will not display any graphics overlay from the digital terrestrial STT 600. As is known, a television guide (abbreviated herein as “guide”) can be overlayed onto the program being viewed by the viewer on the TV 180. However, the overlaying of the guide onto programming from digital channels, and the absence of such a guide when viewing programs from analog channels, results in non-uniform displays to the viewer. In that regard, FIGS. 7 through 12 seek to provide methods for uniformly displaying analog channels, digital channels, and the guide on the TV 180.

FIG. 7 shows an embodiment of a process, among others, for switching from an analog channel to a guide. As noted above, the analog channels, in the embodiments of FIGS. 4 through 6, are displayed on the TV 180 by bypassing the digital circuitry of the STTs 400, 500, 600. Thus, in one embodiment, among others, the visual display to the viewer can be maintained uniform by removing the broadcast contents when displaying the guide. As shown in FIG. 7, when the TV 180 is presently displaying the broadcast contents from an analog TV channel, and the viewer selects a guide option (e.g., through a remote controller), the TV tuner is set (710) to receive its display contents from a set-top terminal (STT), such as, for example, the STTs 400, 500, 600 described above. The STT then sets (720) its switch setting for digital tuning. In other words, the switch in the STT is set to electrically couple the TV 180 to the digital processing circuitry, as explained above. The graphics overlay logic 160 graphically creates (730) the guide, which is then sent (740) to the RF modulator 170 for subsequent modulation and display at the TV 180.

For some embodiments, when the viewer selects the guide option, the processor in the STT instructs the STT to deactivate its audio and video outputs, so that the backdrop of the guide will be blank. Thus, from the viewer's perspective, there is a seamless transition from analog channels, for which guides are often unavailable, to a guide. For other embodiments, the STT need not tune to a blank channel, but, rather, have a guide displayed in place of the digital channel display.

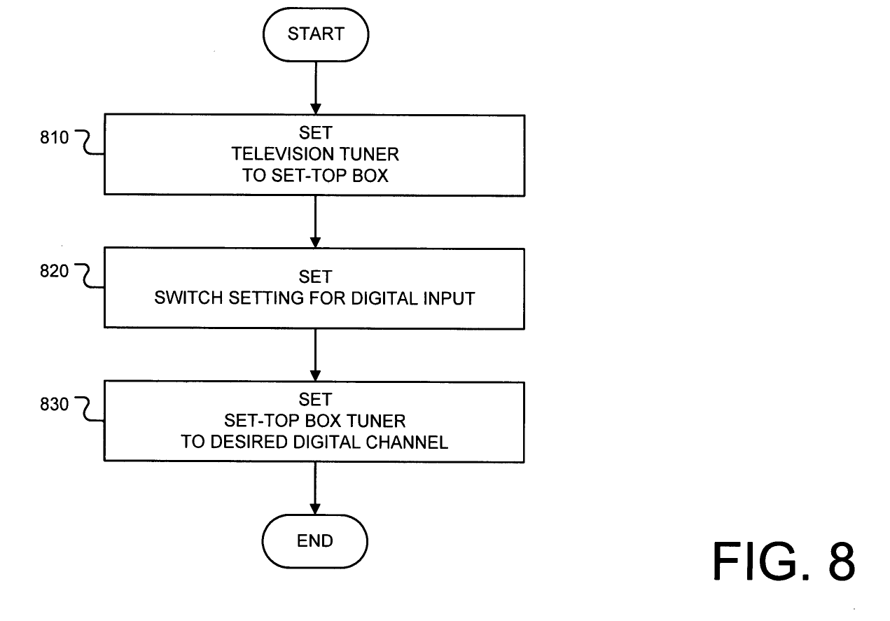

FIG. 8 shows an embodiment of a process, among others, for switching from an analog channel to a digital channel. As noted above, when analog channels are passed through the STT, the switch is set to receive broadcast signals from the analog source, and the TV tuner is set to the appropriate analog channel. Thus, when a viewer is presently viewing an analog channel and selects a digital channel for viewing, the STT sets (810) the TV tuner to receive signals from the STT. Once the TV 180 is set to display the broadcast contents that are processed by the STT, the STT sets (820) its switch setting for digital tuning. Thereafter, the STT sets (830) the STT tuner to the selected digital channel. Thus, from the viewer's perspective, there is a seamless transition from analog channels to digital channels.

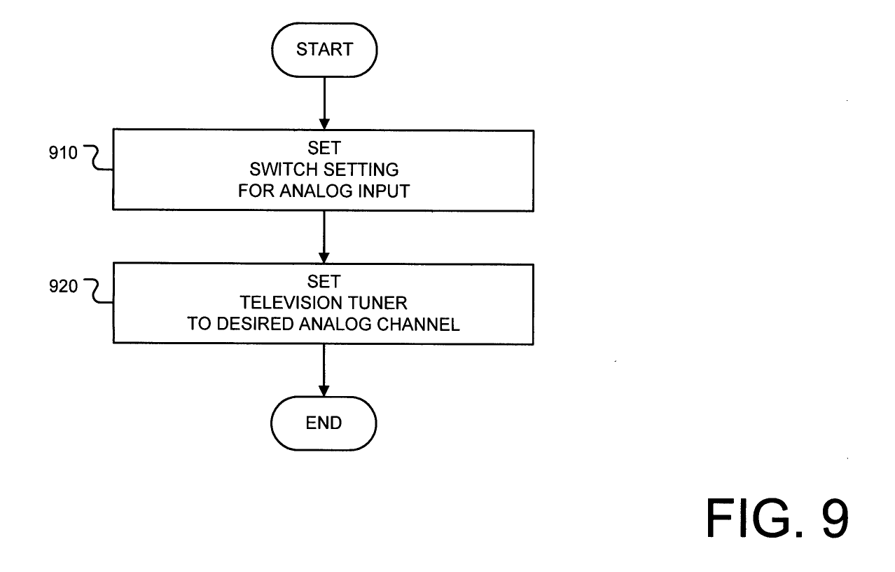

FIG. 9 shows an embodiment of a process, among others, for switching from a digital channel to an analog channel, which is the reverse of the process of FIG. 8. As shown in FIG. 9, when a viewer is viewing a digital channel, then the STT is configured to process and output the contents of the digital broadcast signal. Thus, when a viewer changes the channel to an analog channel, then the STT sets (910) its switch setting to receive analog input. In other words, the switch is set (910) so that the analog signal from the cable or the aerial antenna is passed through the STT. In addition to setting (910) the switch for analog input, the STT sets (920) the TV tuner to the desired analog channel. Thus, from the viewer's perspective, there is a seamless transition from digital channels to analog channels.

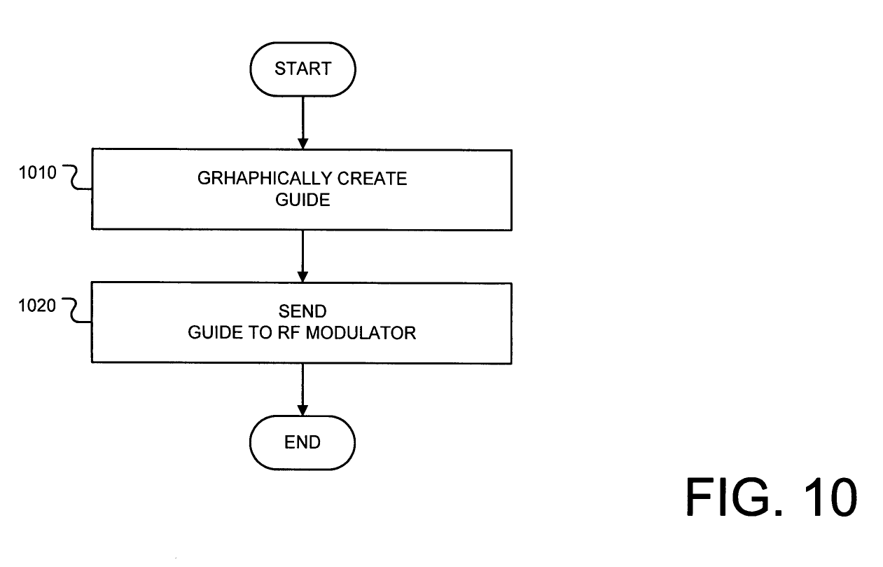

FIG. 10 shows an embodiment of a process, among others, for switching from a digital channel to a guide. Since the guide is generated by the graphics overlay logic 160, the switch from digital channels to a guide is relatively straightforward. When the viewer selects the guide option, the STT graphically creates (1010) the guide. That guide is sent (1020) to the RF modulator for modulation and output to the TV 180.

For some embodiments, the STT audio and video channel outputs are deactivated, so that the guide will be displayed with a blank backdrop. In that regard, the guide will appear uniform, regardless of whether or not the viewer has switched to the guide from an analog channel or a digital channel. The removal of the background (e.g., the deactivation of audio and video) makes the transition from analog-to-guide and the transition from digital-to-guide virtually indistinguishable. For other embodiments, an operator (e.g., cable operator) can provide a guide background channel, which is a digital channel that has guide information. Thus, when a subscriber (or user) selects the guide background channel, that information is broadcast from the operator to the subscriber.

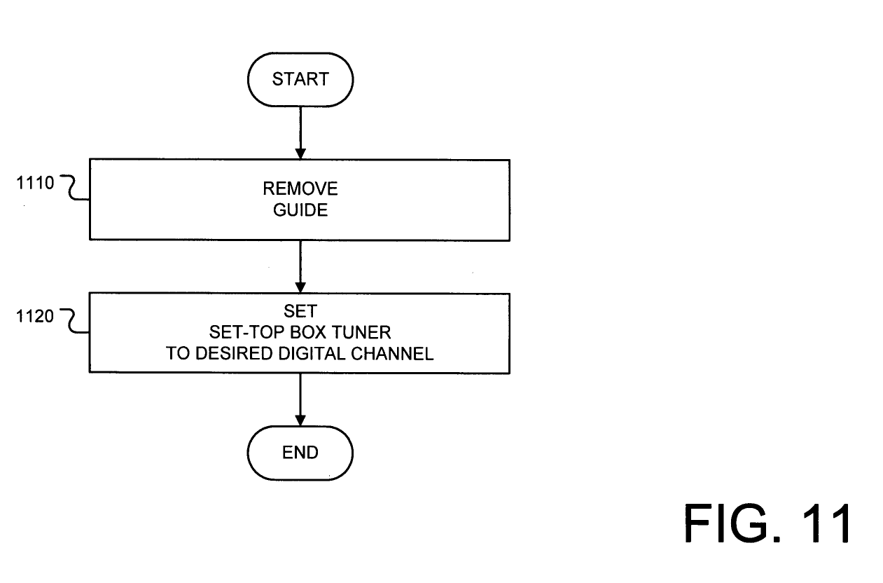

FIG. 11 shows an embodiment of a process, among others, for switching from a guide to a digital channel, which is the reverse of the process of FIG. 10. As such, when a viewer is viewing a guide, and selects a digital channel for viewing, the STT removes (1110) the guide, and sets (1120) the digital tuner to the desired digital channel. Since both the guide and the digital channel are directed through the digital processing circuitry in the STT, there is no need for the STT to change its switch position in the embodiment of FIG. 11.

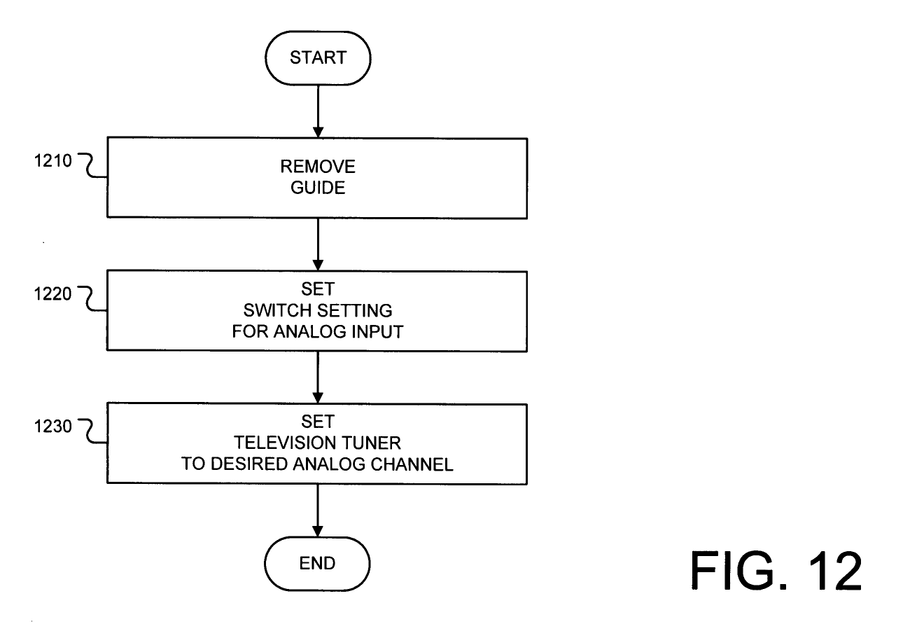

FIG. 12 shows an embodiment of a process, among others, for switching from a guide to an analog channel. As noted above, the guide is provided by the digital processing circuitry of the STT. Thus, when a guide is displayed to the viewer, the switch in the STT is set to the digital processing circuitry. From viewing the guide, when a viewer selects an analog channel, the STT removes (1210) the guide, sets (1220) the switch to receive analog input, and sets (1230) the TV tuner to the desired analog channel. It can be appreciated that the step of removing the guide is optional, since the setting of the switch will sever any signal from the digital processing circuitry, which supplies the guide. As shown in FIG. 12, the analog channel is passed through the STT directly to the TV 180, which is now tuned to the analog channel.

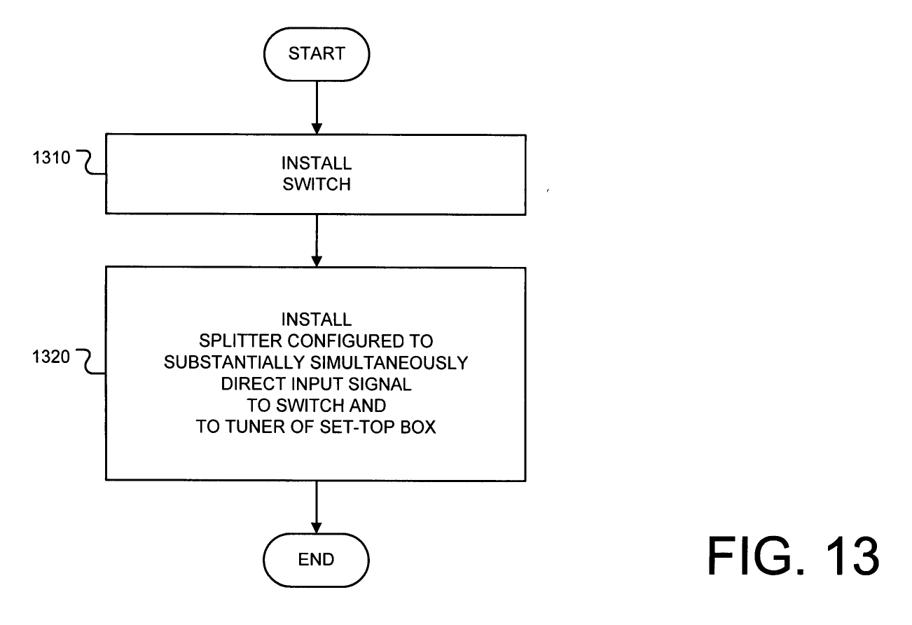

By including a switching mechanism in the STT (e.g., by installing a switching), a viewer can seamlessly switch between analog channels, digital channels, and a guide. FIG. 13 shows an embodiment of a process, among others, for fabricating a digital STT, which is configured to transparently provide digital broadcast channels, analog broadcast channels, and a guide to a viewer, all with relatively little intrusiveness to the viewer. As shown in FIG. 13, one process, among others, for fabricating such an STT comprises the steps of installing (1310) a switch in the STT, and also installing (1320) a splitter in the STT. The splitter is configured to substantially simultaneously direct the input signal to the switch and to the tuner of the STT. The switch, when properly connected to the processor in the STT, can switch between outputting digital broadcast signals, and passing through analog broadcast signals.

As shown in FIGS. 4 through 13, with the various disclosed embodiments, a viewer can seamlessly transition between analog and digital broadcast channels with very little inconvenience to the user. Additionally, both analog and digital broadcast channels can be provided to the viewer without the cost of installing onto a STT relatively expensive hardware, such as, for example, and analog tuner and an up-down converter.

The processor 430, 530 and the graphics overlay logic 160 can be implemented in hardware, software, firmware, or a combination thereof. In the preferred embodiment(s), the processor 430, 530 and the graphics overlay logic 160 are implemented in hardware using any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In an alternative embodiment, the processor 430, 530 and the graphics overlay logic 160 are implemented in software or firmware that is stored in a memory and that is executed by a suitable instruction execution system.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

Although exemplary embodiments have been shown and described, it will be clear to those of ordinary skill in the art that a number of changes, modifications, or alterations to the invention as described may be made. For example, while the embodiments show channel selection by the viewer through a remote controller, it should be appreciated that the channels may be changed through a front-panel display, as is known in the art.

All such changes, modifications, and alterations should therefore be seen as within the scope of the disclosure.

What is claimed is:

1. A set-top terminal, comprising:
an input port configured to receive broadcast signals, the broadcast signals comprising digital signals, the broadcast signals further comprising analog signals;
a splitter coupled to the input port, the splitter configured to direct the received broadcast signal to a first path, the splitter further being configured to direct the received broadcast signal to a second path;
digital tuning circuitry located in the first path, the digital tuning circuitry being configured to process the digital signals, the digital tuning circuitry further being configured to output an output signal for display on a television;
a switch having a first switch position and a second switch position, the switch being configured to receive the output signal when the switch is in the first switch position, the switch further being configured to convey the output signal to the television when the switch is in the first position, the switch further being configured to receive the broadcast signal from the second path when the switch is in the second switch position, the switch further being configured to convey broadcast signal to the television when the switch is in the second position; and
a processor coupled to the switch, the processor being configured to selectively change the switch between the first switch position and the second switch position.

2. The system of claim 1, the broadcast signal being received from a cable network.

3. The system of claim 1, the broadcast signal being received from an antenna.

4. The system of claim 1, further comprising an infrared (IR) receiver configured to receive an IR signal, the received IR signal being indicative of a television channel.

5. The system of claim 4, the processor being coupled to the IR receiver, the processor being configured to receive an electrical signal, the electrical signal being indicative of the television channel, the processor further being configured to change the switch position as a function of the television channel.

6. The system of claim 4, further comprising an infrared (IR) transmitter coupled to the processor, the IR transmitter being controllable by the processor, the IR transmitter being configured to transmit an IR signal, the transmitted IR signal being configured to change a channel on a television.

7. The system of claim 6, the processor further being configured to substantially simultaneously control the IR transmitter and change the switch position.

8. The system of claim 6, the digital tuning circuitry comprising graphics overlay logic configured to generate a television guide, the digital tuning circuitry being controllable by the processor.

9. A set-top terminal, comprising:
a first input port configured to receive digital broadcast signals;
a second input port configured to receive analog broadcast signals;
digital tuning circuitry configured to process the digital signals, the circuitry further being configured to output an output signal for display on a television;
a switch having a first switch position and a second switch position, the switch being configured to receive the output signal when the switch is in the first switch position, the switch further being configured to convey the output signal to the television when the switch is in the first switch position, the switch further being configured to receive the analog broadcast signal when the switch is in the second switch position, the switch further being configured to convey the analog broadcast signal to the television when the switch is in the second position; and
a processor coupled to the switch, the processor being configured to selectively change the switch position between the first switch position and the second switch position.

10. The system of claim 9, the digital broadcast signal being received from a satellite network.

11. The system of claim 9, the digital broadcast signal being received from a cable network.

12. The system of claim 9, the digital broadcast signal being received from an antenna.

13. The system of claim 9, the analog broadcast signal being received from a cable network.

14. The system of claim 9, the analog broadcast signal being received from an antenna.

15. The system of claim 9, further comprising means for receiving an infrared signal, the infrared signal being indicative of a television channel.

16. The system of claim 9, further comprising an infrared (IR) receiver configured to receive an IR signal, the received IR signal being indicative of a television channel.

17. The system of claim 16, the processor being coupled to the IR receiver, the processor being configured to receive an electrical signal, the electrical signal being indicative of the television channel, the processor further being configured to change the switch position as a function of the television channel.

18. The system of claim 16, further comprising an infrared (IR) transmitter coupled to the processor, the IR transmitter being controllable by the processor, the IR transmitter being configured to transmit an IR signal, the transmitted IR signal being configured to change a channel on a television.

19. The system of claim 18, the processor further being configured to substantially simultaneously control the IR transmitter and change the switch position.

20. The system of claim 18, the digital tuning circuitry comprising graphics overlay logic configured to generate a television guide, the graphics overlay logic being controllable by the processor.

21. A method comprising the steps of:
installing a splitter in a digital set-top terminal, the splitter being configured to receive a broadcast signal, the splitter further being configured to direct the broadcast signal to a first path, the first path having digital tuning circuitry, the digital tuning circuitry being configured to process the broadcast signal to produce an output signal for display on a television, the splitter further being configured to direct the broadcast signal to a second path; and
installing a switch in the second path, the switch being configured to receive the broadcast signal from the splitter, the switch further being configured to receive the output signal from the digital tuning circuitry, the switch further being configured to select between the output signal from the digital tuning circuitry and the broadcast signal, the selected signal for output to the television.

22. The method of claim 21, the splitter further being configured to substantially simultaneously direct the broadcast signal to the switch and the digital tuning circuitry.

23. A method for switching to a television guide, the method comprising the steps of:
receiving a signal indicative of the television guide channel; and
in response to receiving the signal, generating a command for a tuner on a television, the command being generated at a digital set-top terminal, the command being for setting the television to receive input from the digital set-top terminal.

24. The method of claim 23, further comprising the step of:
in response to receiving the signal, setting the tuner of the digital set-top terminal to the television guide channel.

25. A method for switching from an analog television channel to a television guide, the method comprising the steps of:
receiving a signal indicative of the television guide; and
in response to receiving the signal:
generating a command for a tuner on a television, the command being generated at a digital set-top terminal, the command being for setting the television to receive input from the digital set-top terminal; and
graphically creating the television guide for display on the television, the television guide being created by the digital set-top terminal.

26. The method of claim 25, further comprising the step of deactivating an audio output on the digital set-top terminal.

27. A method for switching from an analog television channel to a digital television channel, the method comprising the steps of:
receiving a signal indicative of the digital television channel; and
in response to receiving the signal:
generating a command for a tuner on a television, the command being generated at a digital set-top terminal, the command being for setting the television to receive input from the digital set-top terminal; and
setting a tuner of the digital set-top terminal to the digital television channel.

28. A method for switching from a digital television channel to an analog television channel, the method comprising the steps of:
receiving a signal indicative of the analog television channel; and
in response to receiving the signal
generating a command for a tuner on a television, the command being generated at a digital set-top terminal, the command being for setting the television to the analog television channel; and
providing an output for display on the television, the output being provided from the digital set-top terminal, the output corresponding to the analog television channel.

29. A method for switching from a digital television channel to a television guide, the method comprising the steps of:
receiving a signal indicative of the television guide; and
in response to receiving the signal, graphically creating the television guide for display on a television, the television guide being created by a digital set-top terminal.

30. The method of claim 29, further comprising the step of deactivating an audio output on the digital set-top terminal.

31. A method for switching from a television guide to a digital television station, the method comprising the steps of:
receiving a signal indicative of the digital television station; and
in response to receiving the signal:
removing the television guide; and
setting a tuner of the digital set-top terminal to the digital television channel.

32. A method for switching from a television guide to an analog television station, the method comprising the steps of:
receiving a signal indicative of the analog television station; and
in response to receiving the signal:
removing the television guide;
generating a command for a tuner on a television, the command being generated at a digital set-top terminal, the command being for setting the television to the analog television channel; and
providing an output for display on the television, the output being provided from the digital set-top terminal, the output corresponding to the analog television channel.
